(19) United States
(12) Patent Application Publication
(10) Pub. No.: US 2014/0218587 A1
(43) Pub. Date: Aug. 7, 2014

(54) DOUBLE SIDED CAMERA MODULE

(71) Applicant: MOTOROLA MOBILITY LLC, Libertyville, IL (US)

(72) Inventor: Hardik D. Shah, Hoffman Estates, IL (US)

(73) Assignee: MOTOROLA MOBILITY LLC, Libertyville, IL (US)

(21) Appl. No.: 13/761,261

(22) Filed: Feb. 7, 2013

(51) Int. Cl. G03B 5/00

(52) U.S. Cl. CPC G03B 5/00
USPC 348/340

(57) ABSTRACT

A multi-sided camera module, having a multiple lenses directed in different directions and multiple image sensors in a housing frame is disclosed. The multiple lenses can selectively be aligned with any of the multiple image sensors by positioning a mirror assembly disposed in an internal region of the housing frame to relay images received from any one of the lenses to any one of the image sensors. Such multi-sided camera modules can be included in electronic devices in which a camera pointing in a particular direction is necessary for specific functionality, such as taking digital photographs or conducting video conferences.

### BACKGROUND

The demand for smaller, lighter, and less expensive electronic devices continues to increase. As a result, manufacturers of electronic devices, such as laptop computers, tablet computers, and smartphones, are continually looking for ways to decrease the size of such devices in addition to decreasing the associated cost of the bill of materials. Reducing the overall dimensions of the form factor of an electronic device or the bill of materials often means reducing the number or size of the internal components.

In attempts to reduce the size of electronic devices that include imaging devices, such as camera phones, various approaches have been developed to reduce the size of the required camera modules. One issue with such approaches is that conventional techniques of miniaturization often increase the cost of such components. Thus, to reduce the size of a camera module in an electronic device, manufacturers must carefully weigh the space savings with the increase in cost. Accordingly, to reduce both the cost and size of the camera module, some manufacturers have turned to using smaller and less expensive image sensors. However, due to the trend of including both front and back facing cameras in devices, such as smartphones and tablet computers, the reduction in device size and cost savings of such minimization efforts have been negated because the bill of materials for electronic devices that require a front and rear facing camera typically require two separate camera modules. Thus, the space required inside electronic devices for camera modules and the cost associated with the camera modules is doubled.

### BRIEF DESCRIPTION OF THE DRAWINGS

FIG. 1 illustrates an electronic device having a front facing and a rear facing camera module according to various embodiments of the present disclosure.

FIG. 2 is a block diagram of an electronic device having a front facing and a rear facing camera module according to various embodiments of the present disclosure.

FIG. 3 is a flowchart of a method for operating a two-sided camera module according to various embodiments of the present disclosure.

FIG. 4 is a schematic of a two-sided camera module that includes a single image sensor in two configurations, according to various embodiments of the present disclosure

FIG. 5 is a schematic of a two-sided camera module that includes two image sensors in two configurations, according to various embodiments of the present disclosure.

FIG. 6 is a schematic of a two-sided camera module that includes two image sensors in two configurations, according to various other embodiments of the present disclosure.

### DETAILED DESCRIPTION

Described herein are techniques for apparatuses, systems, and methods for two-sided camera modules for use in various types of electronic devices. In the following description, for purposes of explanation, numerous examples and specific details are set forth in order to provide a thorough understanding of particular embodiments. Particular embodiments as defined by the claims may include some or all of the features in these examples alone or in combination with other features described below, and may further include modifications and equivalents of the features and concepts described herein.

One embodiment of the present disclosure is directed toward a two-sided camera module having a housing frame having multiple walls arranged around an internal region. A first lens, having a first optical axis, can be coupled to a first wall. A second lens, having a second optical axis, can be coupled to a second wall. An image sensor, having an active area, can be disposed on a first side of a third wall, wherein the third wall is adjacent to the first and second walls. Such two-sided camera modules can also include a mirror positioner coupled to a fourth wall and disposed in the internal region of the housing frame. A mirror, having a reflective surface, can be coupled to the mirror positioner. The mirror positioner can position the mirror relative to the active area of the image sensor to align the active area of the image sensor alternately with the first lens and with the second lens via the reflective surface of the mirror.

Other embodiments of the present disclosure are directed toward an electronic device having a processor, a memory coupled to the processor, and a two-sided camera module coupled to the processor and the memory. The two-sided camera module can include a front facing lens, having a first optical axis, and a rear facing lens, having a second optical axis. The two-side camera module can also include a first image sensor, having a first active area and disposed adjacent to the front facing lens and the rear facing lens. The first active area can include a plane parallel to the first optical axis. The two-sided camera module can also include a mirror assembly, having an electronically controlled actuator and a reflective surface disposed between the front facing lens and the rear facing lens. The electronically controlled actuator can move the reflective surface relative to the first active area of the first image sensor to align the first active area of the first image sensor alternately with the front facing lens and the rear facing lens via the reflective surface of the mirror in response to control signals received from the processor.

Yet other embodiments of the present disclosure include a method that can include receiving, from a user input device, a first command signal at a controller of a two-sided camera module. The two-sided camera module can include a front facing lens and a rear facing lens. The two-sided camera module can also an image sensor, having an active area, disposed adjacent to the front facing lens and the rear facing lens, and a mirror assembly. The mirror assembly can include an electronically controlled actuator and a reflective surface disposed between the front facing lens and the rear facing lens. Such methods can include, activating, in response to the first command signal, the electronically controlled actuator to move the reflective surface coupled to the electronically controlled actuator into a first position relative to the front facing lens, the rear facing lens, and the image sensor, to define an first optical path from the front facing lens to the active area of the image sensor via the reflective surface.

Particular embodiments include multi-sided camera modules for use in various types of electronic devices, such as smart phones and tablet computers, that include cameras, or other imaging devices, that point in multiple directions, e.g., a front-facing and rear-facing camera. Such multi-sided camera modules can include a housing frame having mounting components on various walls with surfaces for mounting simple and compound lenses and optical filters that are directed in different directions. For example, the lenses can be directed in opposite directions, e.g., offset by 180°, or they can be directed in directions offset by angles less than 180°. The multi-sided camera module can also include one or more image sensors disposed in the housing frame. Using a moveable mirror, the multi-side camera module can selectively align the one or more image sensors with any of the lenses by reflecting light received through the selected lenses onto the active area of the selected image sensor. Such embodiments are advantageous over conventional solutions for multi-camera devices because use of the moveable mirror can reduce the necessary number of camera modules from many to one. This reduction in the number of camera modules not only saves space in electronic devices that include such multi-sided camera modules, thus allowing for smaller form factors, but it can also reduce the cost associated with the multi-camera capability by reducing the number of expensive electronic components, e.g., high resolution image sensors and controllers.

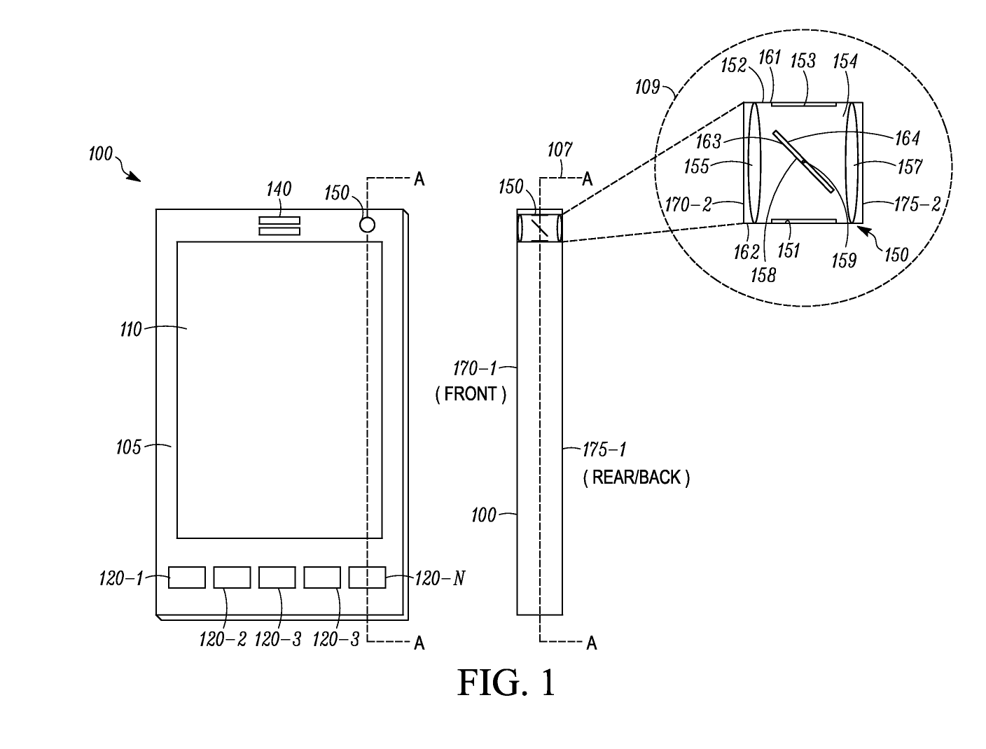

FIG. 1 illustrates electronic device 100 that includes a two-sided camera module 150 according to various embodiments of the present disclosure. Electronic device 100 can include various types of stationery, portable, and mobile computing devices, including, but not limited to, desktop computers, laptop computers, tablet computers, and smartphones. As shown in FIG. 1, electronic device 100 includes an enclosure 105 that forms the external structure and the framework to which other internal and external components can be attached. In some embodiments, electronic device 100 can include a display/input device 110. Such display/input devices can include light emitting diode (LED) displays, liquid crystal displays (LCDs), as well as various types of resistive, capacitive, and inductive touchscreen devices for implementing various types of finger and stylus-based user interfaces. Similarly, electronic device 100 can also include a number of physical buttons 120, such as dedicated or multifunction buttons or keys. In some embodiments, the physical buttons 120 can include a standard or proprietary keyboard for entering text, e.g., a QWERTY keyboard (not shown).

FIG. 1 also illustrates a side view 107 of electronic device 100, as well as an extended side view 109 of the two-sided camera module 150. As shown in the expanded side view 109, various embodiments of the two-sided camera module 150 can include various constituent components. The two-sided camera module 150 can include a housing frame 152. Housing frame 152 can include a number of materials and elements for creating a frame to which the various other components of the two-sided camera module 150 can be attached or mounted. For example, housing frame 152 can include a number of walls attached to one another and disposed around an internal region 154. Internal region 154 can include a central cavity in which mirror 158 and electronically controlled mirror positioner 159 can be disposed.

In various embodiments, the housing frame 152 can include a front side wall 170-2 and a rear/back side wall 175-2 corresponding to the front side 170-1 and rear/back side 175-1 of the electronic device 100. The front side wall 170-2 can include a mount device or other interface for attaching or mounting front facing lens 155. Similarly, rear/back side 175-2 can include a mounting device or other interface for attaching or mounting the rear/back facing lens 157. Such mounting devices can include various types of threaded or bracketed mounts that match or correspond to lens/filter mounts, in which lenses and filters are disposed, e.g., lens tubes. In other embodiments, the mounting device or other interfaces can include various surfaces to which the lenses and filters can be adhered, e.g., cemented into place using optical cement or epoxy.

In some embodiments, the front facing lens 155 and the rear/back facing lens 157 can include various types of imaging lenses. For example lenses 155 and 157 can include simple or compound lenses having various optical powers and profiles, such as convex and concave symmetrical and asymmetrical surfaces. In related embodiments, the lenses 155 and 157 can include both optical and non-optical elements. For example, the lenses 155 and 157 can include optical mounts, such as threaded and unthreaded lens tubes, as well as optical lens elements. The optical mounts can include metal, plastic, and composite materials selected for structural strength, rigidity, and weight. The optical lens elements can include various materials selected for weight, optical properties, and thickness. For example, the optical lens element materials can include, but are not limited to, glass, acrylic, and polycarbonate.

The lenses 155 and 157 can be mounted in housing frame 152 such that each lens is directed in an opposite direction. Accordingly, front facing lens 155 can image objects on the front side 170-1 of electronic device 100, while rear/back facing lens 157 can image objects on the rear/back side 175-1 of electronic device 100. While the front facing lens 155 and the rear/back facing lens 157 are shown as being angularly offset from one another by 180°, the lenses can also be arranged with smaller angular offset without departing from the spirit or scope of the present disclosure. Accordingly, while the optical axes of lenses 155 and 157 can be parallel to one another, they can also be angularly offset.

In related embodiments, the housing frame 152 can include walls 161 and 162 that are adjacent to or abutted to the front facing wall 170-2 and/or rear/back wall 175-2. In some embodiments, such as the example shown in FIG. 1, the two-sided camera module 150 can include two image sensors 151 and 153. In the particular example shown, image sensor 151 can be mounted on or coupled to wall 162. Image sensor 153 can be mounted on or coupled to wall 161. As shown, sensors 151 and 153 are disposed in the housing frame 152 such that they are opposite one another, i.e., the active imaging surfaces of each of the image sensors 151 and 153 are parallel to one another. In other embodiments, sensors 151 and 153 can be arranged such that the active areas of each of the sensors are not parallel to one another. As used herein, the active area of the image sensor refers to the light sensitive area having an array of light sensitive elements that, when used in a coordinated manner, are capable of detecting an image received from one of the lenses 155 or 157 to generate a digital representation of the image.

Sensors 151 and 153 can include various types of image sensors. In some embodiments, image sensors 151 and 153 can include charge coupled devices (CCDs) image sensors or complementary metal oxide semiconductor (CMOS) image sensors. In related embodiments, two-sided camera module 150 can also include drive, power, and control circuitry for driving, powering, and controlling image sensors 151 and 153. In some embodiments, the drive, power, and control circuitry can be included in the image sensors 151 and/or 153. Image sensors 151 and 153 can include identical image sensors. In other embodiments, image sensors 151 and 153 can include different image sensors e.g., different sensor types, different sensor sizes, and different sensor resolutions. In such embodiments, a user, a system, or an application can determine which image sensor with which lens will be used to generate an image.

Two-sided camera module 150 can also include a mirror 158 coupled to one or more walls of the housing frame 152 by a movable mirror positioner 159. The mirror 158 can include one or more reflective surfaces. The reflective surfaces of the mirror 158 can be planar or can include optical power, e.g., the reflective surface can be concave or convex according to and/or complementary to the optical properties of the front facing lens 155 or the rear/back facing lens 157.

The electronically controlled mirror positioner 159 can include a controller (not shown) coupled to one or more elements, such as the processor, of the electronic device 100. In response to command signals received from other components of electronic device 100, the mirror positioner 159 can position mirror 158 relative to image sensors 151 and 153, and lenses 155 and 157, to relay images selectively or alternately received through lenses 155 and 157 to either image sensor 151 or 153. In the particular configuration shown in FIG. 1, in which the reflective surface 163 of the mirror 158 is disposed toward image sensor 151, images received through lens 155 can be relayed and imaged onto image sensor 151. In embodiments in which the reflective surface 163 is disposed towards image sensor 153, images received through lens 157 can be relayed and imaged onto image sensor 153.

The relative positions of reflective surfaces 163 and 164 can be changed by rotating mirror 158 about an axis that is perpendicular to the optical axis of the front facing lens 155 and/or rear/back facing lens 157. In such embodiments, mirror 158 can be rotated about an axis (e.g., a z axis) to change the orientation of the reflective surfaces 163 and 164 relative to the lenses 155 and 157 and image sensors 151 and 153 to selectively relay an image onto one or the other of the image sensors 151 and 153. In embodiments in which mirror 158 includes only one reflective surface, images received through only one of the lenses will be relayed and imaged onto only one of the image sensors.

In some embodiments, mirror 158 includes only one reflective surface, e.g., the mirror 158 includes only reflective surface 163 or reflective surface 164. However, in other embodiments, mirror 158 can include reflective surface 163 on one side of mirror 158 and reflective surface 164 on the other side mirror 158. When mirror 158 includes multiple reflective surfaces, images received through lenses 155 and 157 can simultaneously be relayed to or imaged onto image sensors 151 and 153, respectively. Accordingly, images from the front side 170-1 and the rear/back side 175-1 electronic device 100 can be captured simultaneously. For example, two-sided camera module can be operated to capture still and/or video images from the front side 170-1 and the rear/back side 175-1 of electronic device 100 simultaneously.

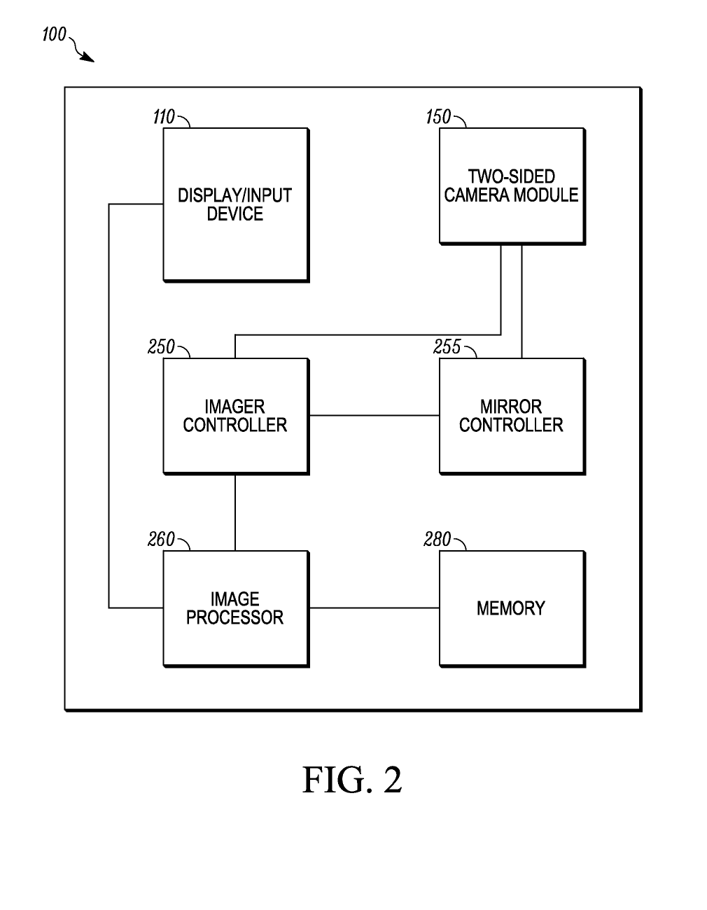

FIG. 2 is a block diagram of electronic device 100 that can include two-sided camera module 150, according to various embodiments of the present disclosure. As shown, electronic device 100 can include a display/input device 110 coupled to an image processor 260. Image processor 260 can be coupled to image controller 250. Image controller 250 can be coupled to mirror controller 255 and two-sided camera module 150. In some embodiments, the mirror controller 255 can be incorporated into the two-sided camera module 150.

The image processor 260 can be implemented using a general purpose processor or can include a specialized imaging processor chip. In embodiments in which the image processor 260 is implemented using a general purpose processor, the image processor 260 can include an instantiation of computer readable instructions stored in memory 280. Memory 280 can include volatile or non-volatile computer readable media. In response to user inputs or input from an application executed in the image processor 260 or a general purpose processor, the image processor 260 can send control signals to the imager controller 250.

The imager controller 250 can determine, in response to the command signals received from the image processor 260, which side, e.g., the front side or the rear/back side, of the electronic device 100 is to be imaged. For example, the image processor, or other processor, of electronic device 100, can execute a camera application wherein the image processor 260 can display a user interface on display/input device 110. The user interface shown in display/input device 110, such as a touchscreen, can include controls operable by user for controlling various camera-like aspects of the camera application and/or the electronic device 110. For example, the user interface can include a region depicting a viewfinder of the camera, a shutter release button, and other camera like settings, e.g., f-stop settings, sensitivity settings, white balance settings, shutter speed setting, etc.

The user interface of the camera application can also include a control or selector for indicating which side of the electronic device a user would like the two-sided camera module 150 to image. For example, user interface can include a toggle button to control the two-sided camera module 150 to receive images from the backside of the electronic device 100, such that the user can use electronic device 100 as a traditional digital camera. Similarly, the user interface can include a selector to control the two-side camera module 150 to receive images from the front side of the electronic device 100, such that the user can use the electronic device for video conferencing or video calls, e.g., the user can look at the display/input device 110 and the front facing lens of the two-sided camera module 150 at the same time.

In response to user input received from a user through the display/input device 110, or to input from an application, the imager controller 250 can determine through which of the lenses of the two-sided camera module 158 images should be received and which image sensor should be used. The imager controller 250 can then send control signals to the mirror controller 255 and/or the two-sided camera module 150. In response to the control signals, the mirror controller 255 can send control signals and/or power to the mirror positioner 159 to position the reflective surface of the mirror 158 relative to the front facing lens 155, the rear/back facing lens 157, and the image sensors 151 and 153, to achieve the desired configuration or optical path. In response to the control signals received from the imager controller 250, the two-sided camera module 150 can operate one or both of the image sensors 151 and 153 to capture still or video images. The captured still or video images can then be sent back through the imager controller 250 to the image processor 260 for display on display/input device 110. In other embodiments, the captured still or video images can be sent back through the imager controller 250 to the image processor 260 to be stored in the memory 280.

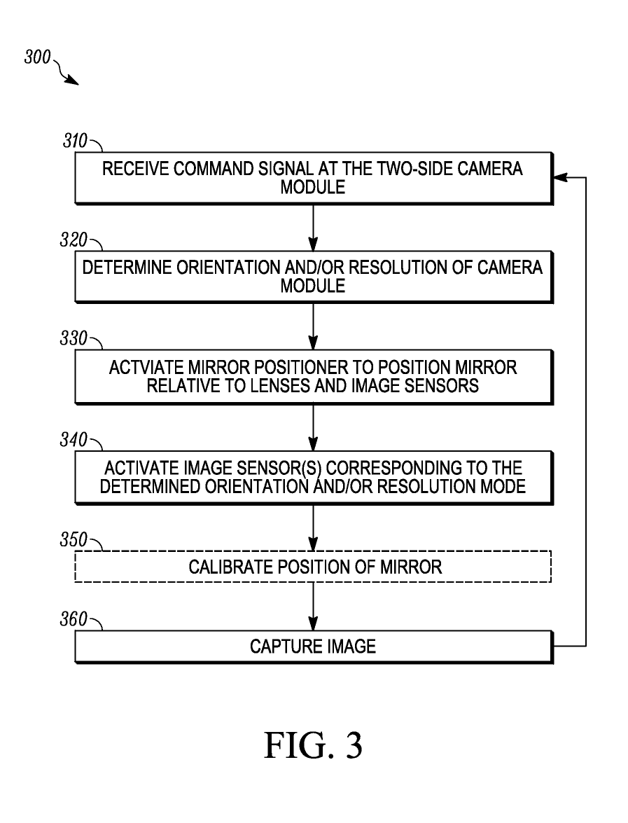

FIG. 3 is a flowchart of a method 300 for operating a two-sided camera module according to various embodiments of the present disclosure. Such methods can begin at action 310, in which the two-sided camera module can receive a command signal from another component in an electronic device. Such command signals can be based on user input or inputs received from an application running on one or more processors of the electronic device. The input can include an indication of the desired orientation of and mode of operation of the two-sided camera module. For example the input can include an indication that the user or application requires that images received from a front side or a backside of the electronic device be captured. The input can also include an indication of other specifications or settings for operating the image sensors of the two-sided camera module. For example, the input can include information regarding the desired frame rate, gain setting, and resolution. In embodiments in which the image sensors of the two-sided camera module are different sizes or resolutions, the input can indicate which of the multiple image sensors should be used. In some scenarios, it may be desirable to use a larger image sensor with a higher resolution, e.g., capturing large scale photographic images, while in other scenarios it may be desirable to use a smaller image sensor with a lower resolution, e.g., operating the two-sided camera module in a viewfinder mode or executing a wireless video conference session in which sensor readout speed and network bandwidth are concerns.

Once the appropriate orientation or configuration of the two-sided camera module is determined, the electronically controlled mirror positioner can be activated to position the mirror relative to the lenses and image sensors of the two-sided camera module in action 330. In some embodiments, activating the mirror positioner includes energizing an actuator, servo, or motor to move and/or rotate the mirror of the two-sided camera module into position to configure an appropriate optical path including the selected lenses and image sensors via the reflective surface of the mirror.

With the mirror in the appropriate position to relay images from the selected lens to the selected image sensor, the selected image sensor can be activated and/or operated corresponding to the selected orientation and/or resolution mode in action 340. In action 360, the image relayed from the selected lens to the selected image sensor can be captured. In some embodiments, capturing image can include sending a live video feed to a display device. In other embodiments, capturing the image can include storing the readout from the sensor to a volatile or nonvolatile memory. Once the image is captured, the method can begin again when a new command is received.

In some embodiments, method 300 can include optional action 350 to calibrate the position of the mirror. Calibration of the position of the mirror can be an automated process in which the mirror positioner includes an automated position calibration routine. The calibration process can also include a manual component in which a user is asked to manually or iteratively adjust the position of the mirror using a set of manual controls in a mirror calibration mode or a mirror calibration application.

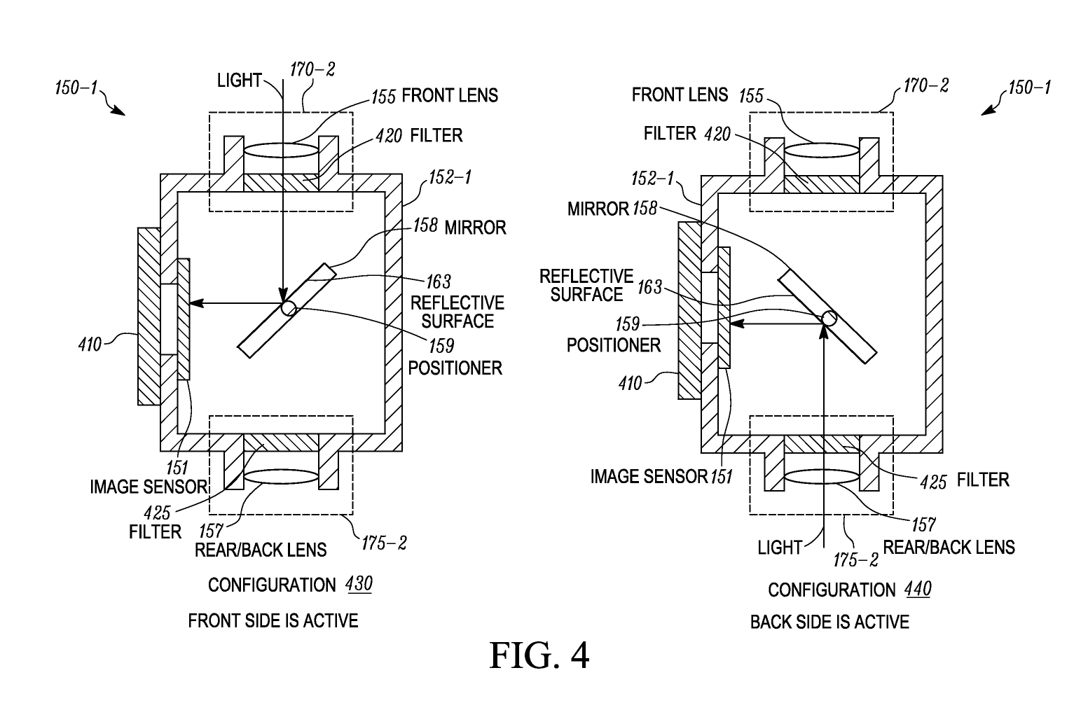

FIG. 4 shows two-sided camera module 150-1 that includes a single image sensor 151. In such embodiments, the two-sided camera module 150-1 can include a housing frame 152-1 onto and into which the other subcomponents of the camera module can be coupled. As shown, the housing frame 152-1 can have a front side 170-2 and a rear/back side 175-2. The image sensor 151 can be mounted to the interior surface of one of the walls of the housing frame 152-1 adjacent to the front side 170-2 and the rear/back side 175-2 walls. In such embodiments, a control circuit 410 can be coupled to the image sensor 151 to receive command signals from and to send image data to other components external to the two-sided camera module 150-1. The control circuit 410 can include a flexible printed circuit board (PCB).

As discussed above in reference to FIG. 1, the front side wall 170-2 of the two-sided camera module 150-1 can include an imaging lens 155 and optical filter 420. Similarly, the rear/back side wall 175-2 can also include an imaging lens 157 and optical filter 425. As shown, the optical filters 420 and 425 can be disposed between the rotating mirror 158 and lenses 155 and 157, respectively. In some embodiments, optical filters 420 and 425 can include various types of optical filters, such as absorptive or interference infrared filters, to alter the spectral profile of the light received by lenses 155 and 157 according to the spectral response of the image sensor, e.g., reduce the amount of infrared light to compensate for disproportionate sensitivity of the image sensor to infrared light. Mirror 158, having reflective surface 163, can be coupled to mirror positioner 159. In some embodiments mirror positioner 159 can include a rotating shaft coupled to an actuator, such as a motor or servo, to rotate mirror 158 about an axis perpendicular to the optical axis of lens 155 or the optical axis of lens 157.

FIG. 4 shows the two-sided camera module 150-1 configured in configuration 430 and configuration 440. In response to command signals received from a processor, or other electronic component, mirror positioner 159 can rotate mirror 158 relative to image sensor 151 and lenses 155 and 157. In configuration 430, the mirror positioner 159 has rotated mirror 158, such that reflective surface 163 is angled to relay light receive by lens 155, and through optical filter 420, onto image sensor 151. In configuration 430, the front side of the two-sided camera module is active. In configuration 440, mirror positioner 159 has rotated mirror 158, such that reflective surface 163 is angled to relay light received through the lens 157, and through optical filter 425, onto image sensor 151. In configuration 440, the backside of the two-sided camera module is active.

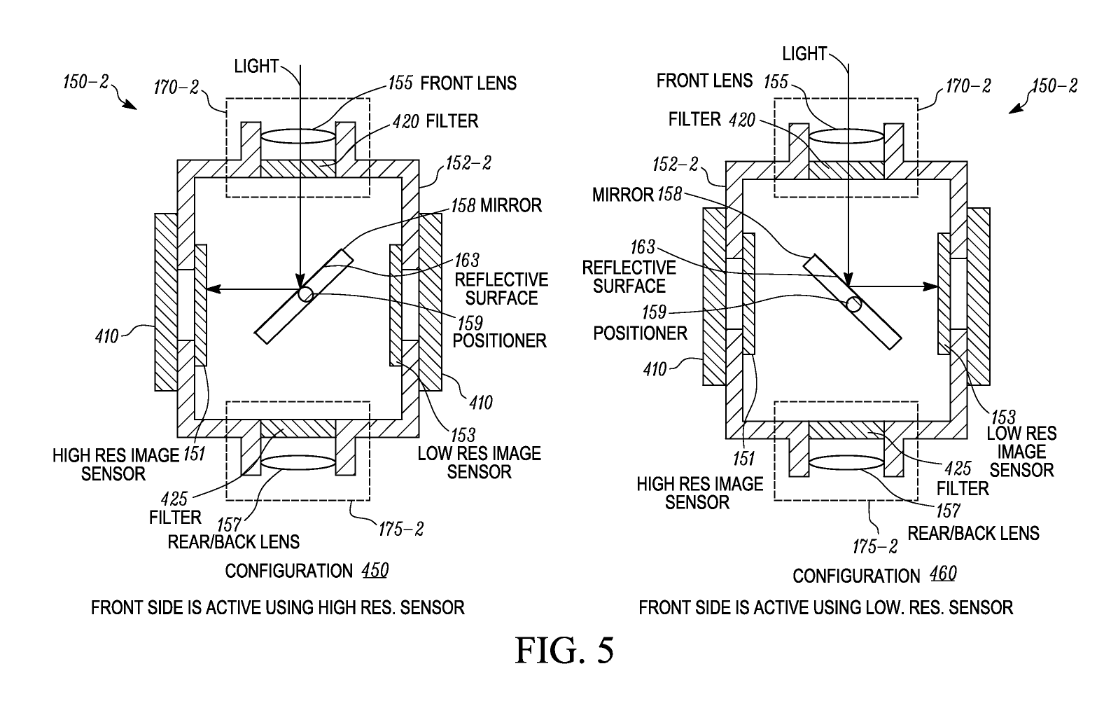

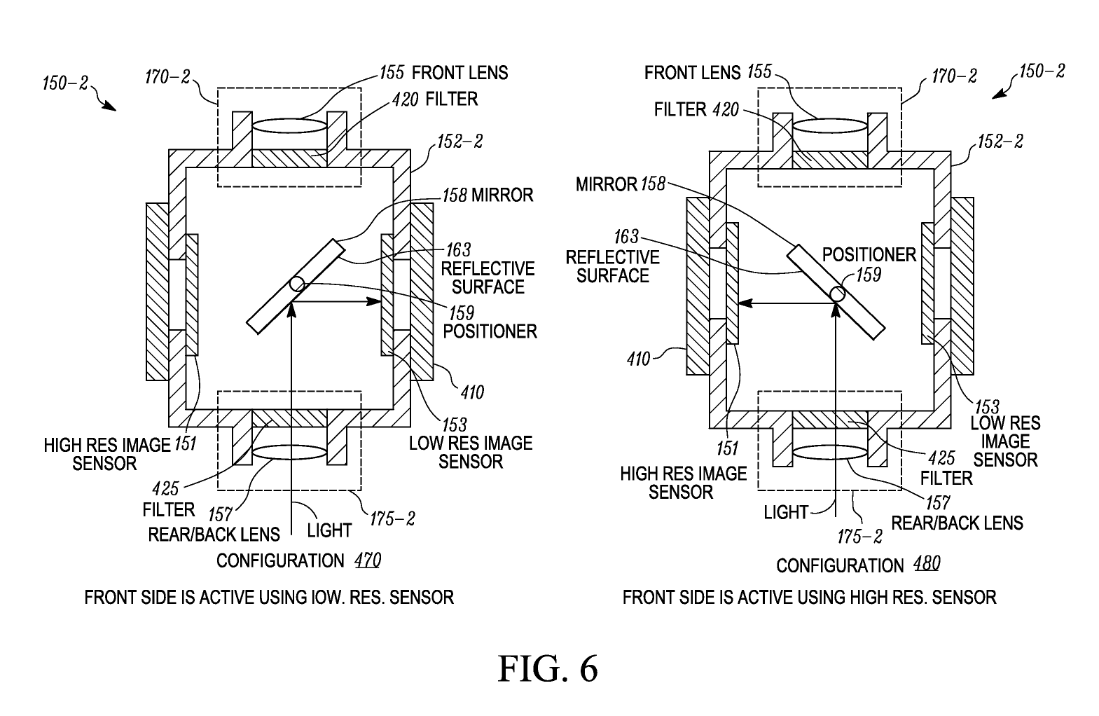

FIGS. 5 and 6 illustrate various configurations for activating the front and back sides of a two-sided camera module 150-2 that includes two image sensors, according to various embodiments of the present disclosure. Two-sided camera module 150-2 includes components similar to those found in two-sided camera module 150-1, and also includes a housing frame 152-2 configured to receive an additional image sensor 153. As shown, housing frame 152-2 can accommodate a first high-resolution image sensor 151 and a second low resolution image sensor 153. Both the high-resolution image sensor 151 and the low resolution image sensor 153 can be disposed on interior surfaces of walls of the housing frame 152-2 that are adjacent to the front side 170-2 and the rear/back side 175-2 of the two-sided camera module 150-2. In such embodiments, the control circuit 410 can be configured to couple to both the high-resolution image sensor 151 and the low resolution image sensor 153 to receive control signals from and to send image data to other electronic components, e.g., a processor.

FIG. 5 illustrates configurations 450 and 460. In configuration 450, in response to control signals, the mirror positioner 159 has rotated mirror 158 so that the reflective surface 163 is positioned relative to the high-resolution image sensor 151 and lens 155, such that light received through lens 155, and through optical filter 420, is relayed onto the active area of high-resolution image sensor 151. In configuration 450, the front side 170-2 of the two-sided camera module 150-2 is active and using the high-resolution image sensor 151. In configuration 460, mirror positioner 159 has rotated mirror 158 so that the reflective surface 163 is positioned relative to the low resolution image sensor 153 and lens 155, such that light received through lens 155, and through optical filter 420, is relayed onto the active area of low-resolution image sensor 153. In configuration 460, the front side 170-2 of the two-sided camera module 150-2 is active in using the low-resolution sensor 153.

FIG. 6 illustrates configurations 470 and 480. In configuration 470, in response to control signals, the mirror positioner 159 has rotated mirror 158 so that the reflective surface 163 is positioned relative to low-resolution image sensor 153 and lens 157, such that light received through lens 157, and through optical filter 425, is relayed onto the active area of low-resolution image sensor 153. In configuration 470, the backside 175-2 of the two-sided camera module 150-2 is active and using the low-resolution image sensor 153. In configuration 480, in response to control signals, the mirror positioner 159 has rotated mirror 158 so that the reflective surface 163 is positioned relative to high resolution image sensor 151 and lens 157, such that light received through lens 157, and through optical filter 425, is relayed onto the active area of high resolution image sensor 151. In configuration 480, the backside 175-2 of the two-sided camera module 150-2 is active and using the high-resolution image sensor 151.

Particular embodiments may be implemented in a non-transitory computer-readable storage medium for use by or in connection with the instruction execution system, apparatus, system, or machine. The computer-readable storage medium contains instructions for controlling a computer system to perform a method described by particular embodiments. The computer system may include one or more computing devices. The instructions, when executed by one or more computer processors, may be operable to perform that which is described in particular embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. The above examples and embodiments should not be deemed to be the only embodiments, and are presented to illustrate the flexibility and advantages of particular embodiments as defined by the following claims. Based on the above disclosure and the following claims, other arrangements, embodiments, implementations and equivalents may be employed without departing from the scope hereof as defined by the claims.

What is claimed is:

1. An apparatus comprising:
a housing frame comprising a plurality of walls disposed around an internal region;
a first lens, having a first optical axis, coupled to a first wall in the plurality of walls;
a second lens, having a second optical axis, coupled to a second wall in the plurality of walls;
an image sensor, having an active area, disposed on a first side of a third wall in the plurality of walls, wherein the third wall is adjacent to the first and second walls;
a mirror positioner disposed in the internal region of the housing frame; and
a mirror, having a reflective surface, coupled to the mirror positioner,
wherein the mirror positioner positions the mirror relative to the active area of the image sensor to align the active area of the image sensor alternately with the first lens and with the second lens via the reflective surface of the mirror.

2. The apparatus of claim 1, wherein the first optical axis of the first lens is parallel to the second optical axis of the second lens.

3. The apparatus of claim 2, wherein the first optical axis of the first lens and the second optical axis of the second lens are collinear.

4. The apparatus of claim 1, wherein the mirror is disposed between the first lens and the second lens.

5. The apparatus of claim 4, wherein the mirror positioner rotates the mirror about an axis perpendicular to the first optical axis to position the mirror.

6. The apparatus of claim 1, further comprising a controller coupled to the image sensor and the positioner, wherein the image sensor controller controls the operation of the image sensor and the positioner.

7. The apparatus of claim 1, further comprising:
a first optical filter coupled to the first wall and disposed between the first lens and the mirror; and
a second optical filter coupled to the second wall and disposed between the second lens and the mirror.

8. The apparatus of claim 7 wherein the first optical filter or the second optical filter comprises an infrared filter.

9. The apparatus of claim 1, further comprising:
a second image sensor, having a second active area, disposed on a first side of a fifth wall in the plurality of walls, wherein the fifth wall is adjacent to the first and second walls and opposite the third wall; and
wherein the mirror positioner further positions the mirror relative to the second active area of the second image sensor to align the second active area alternately with the first lens and the second lens via the reflective surface.

10. An electronic device comprising:
a processor;
a memory coupled to the processor; and
a two-sided camera module coupled to the processor and the memory, and comprising:
a front facing lens, having a first optical axis;
a rear facing lens, having a second optical axis;
an first image sensor, having a first active area, disposed adjacent to the front facing lens and the rear facing lens, and wherein the first active area comprises a plane parallel to the first optical axis;
a mirror assembly, comprising an electronically controlled actuator and a reflective surface, disposed between the front facing lens and the rear facing lens, wherein the electronically controlled actuator moves the reflective surface relative to the first active area of the first image sensor to align the first active area of the first image sensor alternately with the front facing lens and with the rear facing lens via the reflective surface of the mirror in response to control signals received from the processor.

11. The electronic device of claim 10, further comprising an input device, coupled to the processor, for receiving input to initiate sending the control signals to the mirror assembly.

12. The electronic device of claim 10, wherein the two-sided camera module further comprises a second image sensor, having an second active area, disposed adjacent to the front facing lens and the rear facing lens, wherein the second active area comprises a plane parallel to the first optical axis, and wherein the electronically controlled actuator moves the reflective surface relative to the second active area of the second image sensor to align the second active area of the second image sensor alternately with the front facing lens and with the rear facing lens via the reflective surface of the mirror in response to the control signals received from the processor.

13. The electronic device of claim 12, wherein the first image sensor comprises a first sensor type, and the second sensor comprises are second sensor type.

14. The electronic device of claim 13, wherein the first image sensor type is different than the second sensor type.

15. The electronic device of claim 10, wherein the two-sided camera module further comprises:
a first optical filter disposed between the front facing lens and the mirror assembly; and
a second optical filter disposed between the rear facing lens and the mirror assembly.

16. The electronic device of claim 15 wherein the first optical filter or the second optical filter comprises an infrared filter.

17. A method comprising:
receiving, from a user input device, a first command signal at a controller of a two-sided camera module comprising:
a front facing lens;
a rear facing lens;
an image sensor, having an active area, disposed adjacent to the front facing lens and the rear facing lens; and
a mirror assembly, comprising an electronically controlled actuator and a reflective surface, disposed between the front facing lens and the rear facing lens; and
activating, in response to the first command signal, the electronically controlled actuator to move the reflective surface coupled to the electronically controlled actuator into a first position relative to the front facing lens, the rear facing lens, and the image sensor, to define an first optical path from the front facing lens to the active area of the image sensor via the reflective surface.

18. The method of claim 17 further comprising:
receiving, from the user input device, a second command signal at the controller of the two-sided camera module; and
activating, in response to the second command signal, the electronically controlled actuator to move the reflective surface coupled to the electronically controlled actuator into a second position relative to the front facing lens, the rear facing lens, and the image sensor, to define an second optical path from the rear facing lens to the active area of the image sensor via the reflective surface.

19. The method of claim 17, further comprising:
receiving, from the user input device, a second command signal at the controller of the two-sided camera module; and
activating, in response to the second command, the active area of the image sensor to capture an image.

20. A non-transitory computer readable medium comprising instructions for performing the method of claim 17.
